(19) United States
(12) Patent Application Publication
(10) Pub. No.: US 2025/0258660 A1
(43) Pub. Date: Aug. 14, 2025

(54) AUTOMATED CREATION OF GENERATIVE CONTENT AND APPLICATIONS WITH DUAL-LAYER ARCHITECTURE

(71) Applicant: Brain Technologies, Inc., San Mateo, CA (US)

(72) Inventors: Clive Gomes, San Mateo, CA (US); Sheng Yue, San Mateo, CA (US)

(21) Appl. No.: 19/048,772

(22) Filed: Feb. 7, 2025

Related U.S. Application Data
(60) Provisional application No. 63/552,048, filed on Feb. 9, 2024.

(51) Int. Cl. G06F 8/35

(52) U.S. Cl. CPC G06F 8/35

(57) ABSTRACT

A system receives an input from a user directed at a dynamic layout software program. The system generates a representation of the input based at least on the input. The representation specifies at least a user intent to be fulfilled by the program and a set of parameters for fulfilling the user intent. The system identifies an execution blueprint based on the representation from a repository storing a plurality of execution blueprints. The system integrates a set of procedural slots and identifiers of one or more external executable routine tools included in the execution blueprint with the representation of the input to compile a set of ephemeral instructions. The system executes the set of ephemeral instructions to generate a dynamically determined response to the user input.

### CROSS-REFERENCE TO RELATED APPLICATIONS

This application claims the benefit of U.S. Provisional Application No. 63/552,048, filed Feb. 9, 2024, which is incorporated by reference herein in its entirety.

### TECHNICAL FIELD

The present disclosure generally relates to software applications and, particularly, building software applications using natural language and machine-learning models.

### BACKGROUND

Large language models (LLMs) have revolutionized user interface (UI) generation through their ability to understand natural language descriptions and generate corresponding implementation code. These models can interpret user requirements and generate HTML, interactive components, or other UI implementations by leveraging their training on vast datasets of UI designs and code patterns. Advanced systems allow LLMs to use available UI components and tools as building blocks, enabling generation of interfaces using specific design systems or component libraries. However, the existing UI generation methods use a direct coupling between understanding user requirements and generating implementations. Users' feedback may simultaneously affect both how the system interprets requirements and how it generates solutions, making it impossible to evolve either capability independently. This tight coupling means that improvements in understanding user intent are always constrained by current implementation capabilities, and vice versa. Additionally, since these systems focus on immediate generation rather than building persistent understanding, they struggle to preserve aspects of user intent that do not map cleanly to current technical capabilities. When new technical capabilities become available, there is no mechanism to automatically revisit and improve previous implementations since the original intent was not captured separately from its technical realization.

Further, the LLMs, while powerful in their ability to understand and generate text, have inherent limitations. The LLMs are deficient in performing real-time calculations, accessing current information, or interacting with external systems. To overcome these limitations, LLMs are integrated with external tools that provide these additional capabilities. To make tools available to an LLM, each tool is defined with metadata that helps the LLM understand when and how to use each tool appropriately within its reasoning process. Often when generating a response to a user request, the LLM need to repeatedly select and deploy tools. Each step may require active the LLM involvement to determine the next action, format the inputs correctly, and handle the outputs appropriately. Thus, even for repetitive tasks that use the same sequence of tools, the LLM must actively manage each step of the process every time. Moreover, the current integration of the LLM and tools often use previously determine sequences of tools and depends on specific tools being available and functioning at all times. If a tool in the saved sequence becomes unavailable, updates its interface, or experiences temporary downtime, the entire workflow fails. The system may also become stagnant since saved sequences continue using older tools even when better alternatives become available. While it may save some initial decision-making overhead, full LLM involvement may be still required during execution for managing tool interactions and data flow, resulting in limited efficiency gains and potential reliability issues.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a data processing service, in accordance with an embodiment.

FIG. 2A is a conceptual diagram illustrating an example dual-layer structure for a layout software program, in accordance with one or more embodiments.

FIG. 2B is a block diagram graphically illustrating a process for generating a representation of a user input in the semantic abstraction layer, in accordance with one or more embodiments.

FIG. 3 is a block diagram illustrating an example data storage, in accordance with one or more embodiments.

FIG. 4 illustrates a process for generating a dynamically determined response using an execution blueprint in a dynamic layout software program, in accordance with one or more embodiments.

FIG. 5 is a block diagram graphically illustrating a process for using an execution blueprint to generate a dynamically determined response, in accordance with one or more embodiments.

FIG. 6A is a block diagram graphically illustrating a process for data flow through connections in an execution blueprint, in accordance with one or more embodiments.

FIG. 6B is an example section of a set of ephemeral instruction, in accordance with one or more embodiments.

FIG. 7 illustrates a structure of an example neural network is illustrated, in accordance with one or more embodiments.

FIG. 8 is an example machine to read and execute computer readable instructions, in accordance with one or more embodiments.

### DETAILED DESCRIPTION

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments are related to a dynamic layout software program which provides a dynamic user interfaces at a user device. When receiving a user input, the dynamic layout software program generates a dynamically determined response to the user input to be displayed by the dynamic user interface. In one embodiment, a system receives an input from a user directed at a dynamic layout software program. The system generates a representation of the input based at least on the input. The representation specifies at least a user intent to be fulfilled by the program and a set of parameters for fulfilling the user intent. The system identifies an execution blueprint based on the representation from a repository storing a plurality of execution blueprints. Each execution blueprints includes: 1) criteria for matching the respective execution blueprint to a representation of an input, 2) a set of procedural slots, each specifying at least one function for fulling a user intent, and 3) identifiers of one or more external executable routine tools in the respective procedural slots. The system integrates the set of procedural slots and the identifiers of the one or more external executable routine tools with the representation of the input to compile a set of ephemeral instructions. The system executes the set of ephemeral instructions to generate a dynamically determined response to the user input.

The disclosed system introduces a novel dual-abstraction architecture that separates human intent and design thinking from technical implementation constraints in UI creation. This separation enables a focus on capturing and understanding exactly what users want to achieve, independent of how it will be technically realized. Specifically, the separation between semantic and computational layers provides an asynchronous approach to the system evolution where the computational layer need not consider whether a semantic representation was created moments ago or retrieved from long-term storage. Similarly, the semantic layer focuses on understanding and capturing the user intent, unconstrained by how or when that intent may be realized. The semantic layer may evolve frequently, with every user interaction and new intent, whereas the computational layer is driven by changes in technical capabilities, e.g., when new building blocks become available, or others become outdated or unusable. Through distinct semantic and computational layers, each with independent feedback loops, the system may continuously evolve its understanding of user intent while separately and/or asynchronously improving technical implementations. Both layers maintain their independence through separate knowledge repositories, and the computational layer storing platform-agnostic implementation strategies that can be realized differently across platforms or using different building blocks. This system may be applied across various domains including application development, website creation, interface design, and any scenario where user interface elements need to be generated based on human intent.

In another aspect, this disclosure provides a method for generating and reusing tool-based workflows in LLM applications that eliminates the need for continuous LLM engagement during subsequent executions at every step. The system determines workflows in an execution blueprint structure using intent-based slots that abstract functional requirements, allowing multiple tools to be interchangeable within slots. The system generates connections that automatically create transformations between slot interfaces and tool requirements, enabling tool substitution without manual integration. Executions of blueprints using these connections allow data passing between tools and/or through the blueprint without involving the LLMs. In some cases, connections operate as pure code-based transformations, efficiently converting data between slot and tool formats without requiring any runtime language processing. When a blueprint is reused, the system only needs to execute these pre-defined transformations rather than having an LLM generate new transformations for each step. In some implementations, a blueprint may store both its slot structure, and all the connections for its compatible tools. During execution, when a specific tool is selected for a slot, its corresponding connections automatically handle all necessary data transformations. This reduces the LLM's role in subsequent runs to simply selecting an appropriate blueprint and generating its initial inputs, rather than managing the intricate data transformations needed at each step of the workflow. This architecture reduces runtime LLM costs after initial blueprint creation, provides automatic error recovery through tool alternatives, and enables the system to learn and adapt by composing existing blueprints into new patterns while maintaining efficient runtime performance. In this way, users experience fast response times from direct tool usage, while the system gradually builds a library of reusable blueprints. These blueprints then become available as components for future workflows, creating a feedback loop where the system becomes more efficient over time without compromising immediate performance.

### Example System Configuration

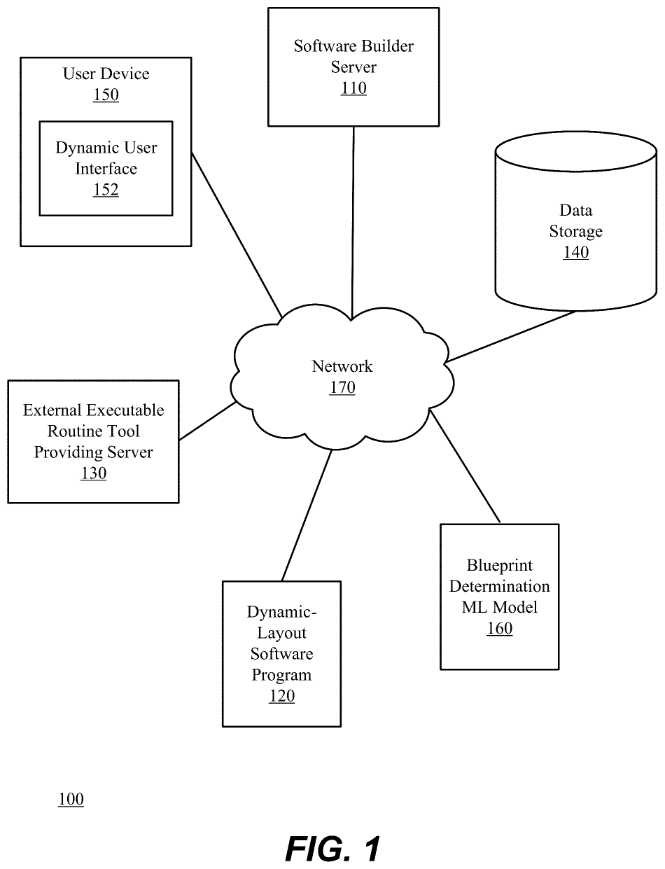

FIG. 1 is a block diagram that illustrates a system environment 100, in accordance with one or more embodiments. The system environment 100 includes a software builder server 110, a dynamic layout software program 120, an executable-routine tool providing server 130 (referred to as “tool provider 130” hereafter), a data storage 140, a user device 150, a blueprint determination machine learning (ML) model 160, and a network 170. The entities and components in the system environment 100 communicate with each other through the network 170. In various embodiments, the system environment 100 includes fewer or additional components. In some embodiments, the system environment 100 also includes different components. While each of the components in the system environment 100 is described in a singular form, the system environment 100 may include one or more of each of the components. Different user devices 150 may also access the dynamic layout software program 120 simultaneously.

The software builder server 110 includes one or more computers that builds a dynamic layout software program 120 which provides a dynamic user interfaces 152 displayed at a user device 150. The content, design, and interaction experience provided by the dynamic layout software program 120 may vary at runtime based on end users' inputs. The software builder server 110 may use natural language processing (NLP) and machine learning techniques to understand and interpret user intent, generate code, and handle various programming tasks such as identifying preexisting applicable routines, creating functions, defining variables, or implementing logic. In some embodiments, the software builder server 110 may access a tool provider 130 which hosts one or more existing routine tools, such as microservices, pre-written software module, and software applications. In one embodiment, the software builder server 110 may use the blueprint determination ML model 160 to generate a plurality of execution blueprints. An execution blueprint may define a serial of functional components that corresponds to a workflow of functions/tasks to be performed to fulfill a user intent. An execution blueprint may be one example implementation method for the software builder server 110 to generate the data aspect of a response to a user input. For example, an execution blueprint may specify what data to be accessed/generated and which functions to be executed to generate the desired data. In some implementations, the software builder server 110 may associate an execution blueprint with a representation of a user input. The software builder server 110 may store the generated execution blueprints in an execution blueprint repository (e.g., stored at a data storage 140). During runtime of the dynamic layout software program 120, the dynamic user interface 152 at the end user device 150 may receive a user input, the software builder server 110 may cause the dynamic layout software program 120 to identify an execution blueprint from the execution blueprint repository based on the associated representation of user input and generate a set of ephemeral instructions using the identified execution blueprint. In some embodiments, during the runtime, the software builder server 110 does not need to access the blueprint determination ML model 160 to generate the set of ephemeral instructions. By executing the set of ephemeral instructions, the software builder server 110 cause the dynamic layout software program 120 to generate a dynamically determined response in the user interface 152 based on the user input in a manner that will be further discussed in this disclosure.

In some embodiments, ephemeral instructions may take the form of instructions that are generated as a response to a user input and may exist temporarily for the purpose of dynamically configuring the user interface. In some embodiments, ephemeral instructions may be cached for a short period but in general not beyond a communication session (e.g., a log on session) between the user and the dynamic layout software program 120. In the context of the dynamic layout software program 120, ephemeral instructions may be dynamically created at runtime based on the specific user request. The instructions allow the dynamic layout software program 120 to render the user interface and relevant data in response to the user input. For example, when the user requests weather information, the ephemeral instructions may specify the data sources and the executable routine tools for presenting the weather data. In turn, the user may transition to managing calendar events. A new set of ephemeral instructions is generated to define the data required for calendar management. In some embodiments, ephemeral instructions may be generated on demand and may be discarded when the instructions are no longer needed, the dynamic layout software program 120 can remain flexible and adaptable to varying user requests without being constrained by the specific executable routine tools.

While in this disclosure the phrase ephemeral instructions are used as an example, in some embodiments, the instructions that are used to render dynamic layout software program 120 may also simply be referred to instructions without the ephemeral aspect.

Various servers in this disclosure may take different forms. In one embodiment, a server is a computer that executes code instructions to perform various processes described in this disclosure. In another embodiment, a server is a pool of computing devices that may be located at the same geographical location (e.g., a server room) or be distributed geographically (e.g., clouding computing, distributed computing, or in a virtual server network). In one embodiment, a server includes one or more virtualization instances such as a container, a virtual machine, a virtual private server, a virtual kernel, or another suitable virtualization instance.

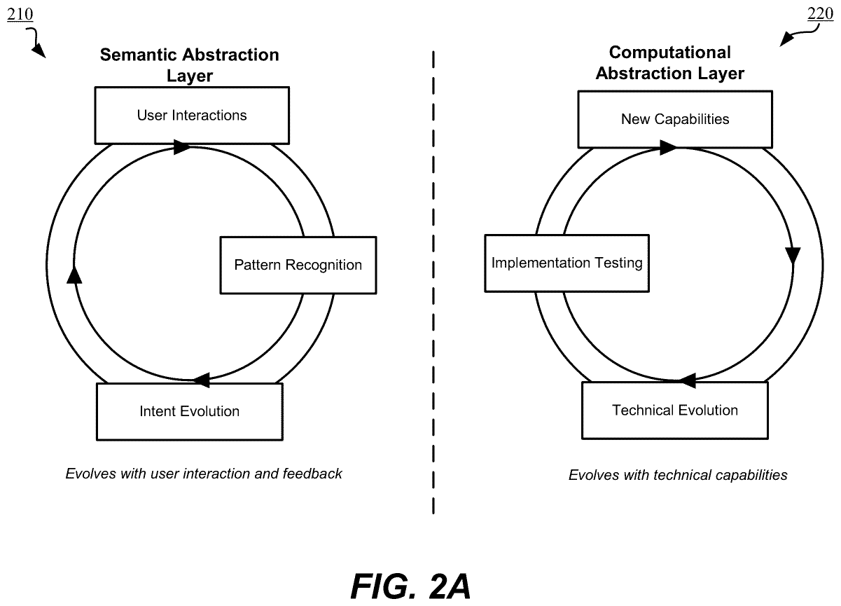

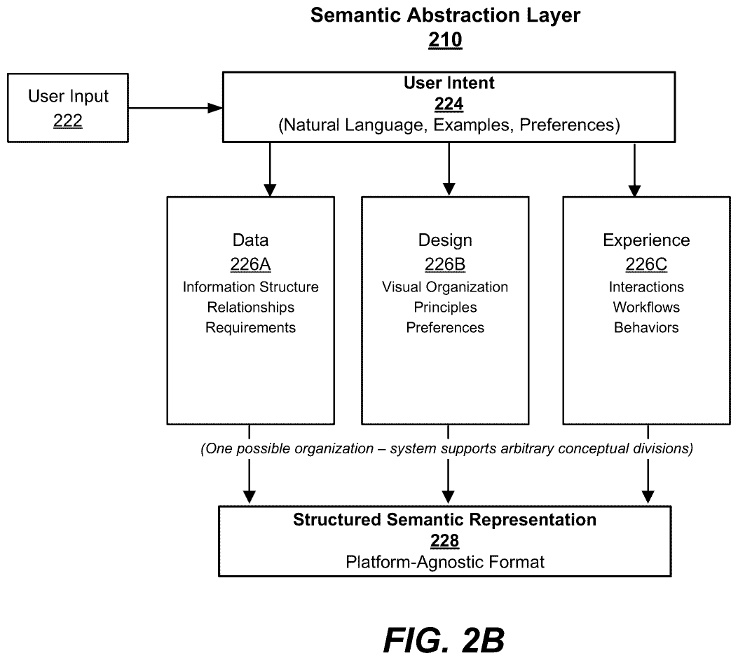

A dynamic layout software program 120 is a software program that is designed to receive end users' input and display a dynamically determined response in a user interface (e.g., dynamic user interface 152). In one embodiment, the dynamic layout software program 120 may not have a fixed user interface layout. In some cases, the dynamic layout software program 120 does not determine its layout until at runtime where an end user provides an input or a command and the dynamic layout software program 120 determines the intent of the end user and the implementation techniques to be performed to fulfill the intent. The dynamic layout software program 120 may provide a dynamic user interface 152 at an end user device 150 for the end user to input data into the dynamic layout software program 120 and receive output response from the dynamic layout software program 120. Examples of the dynamic layout software program 120 are discussed in further details below with reference to FIGS. 2A-8.

The system environment 100 may include one or more tool providers 130. A tool provider 130 may be a third-party server that is made available to the software builder server 110. The tool provider 130 may include various executable routine tools such as pre-built software applications (e.g., a music player, a digital map, a stock trading platform), software modules, machine-learning models (e.g., a large language model (LLM)) and/or microservices (identity service, transaction service, etc.) that are available for the software builder server 110 to use. When the software builder server 110 executes a dynamic layout software program 120, the software builder server 110 may identify executable routine tools to be run in the dynamic layout software program 120. In turn, the software builder server 110 may execute one or more application programming interface (API) calls to request for executable routine tools that are hosted at one or more tool providers 130 to be executed.

In some embodiments, the executable routine tools may be referred to as external executable routine tools. In some embodiments, the external executable routine tools are provided by third-party software providers. In some embodiments, the tools being external does not necessarily require the tools to be operated by a third-party company. Instead, an external executable routine tool may be only external to an execution blueprint that refers to the external executable routine tool. For example, the execution blueprint may include an identifier referring to the external executable routine tool so that the ephemeral instructions generated may include an API call to invoke the external executable routine tool.

A data storage 140 includes one or more computing devices that include memories or other storage media for storing various files and data of the software builder server 110, and/or the tool provider 130. For example, the data storage 140 stores software developer data, end user data for use by the software builder server 110 and the tool provider 130. The data storage 140 also stores trained machine-learning models included in the blueprint determination ML model 160. For example, the data storage 140 may store the set of parameters for a trained machine-learning model on one or more non-transitory, computer-readable media. The data storage 140 uses computer-readable media to store data, and may use databases to organize the stored data. In various embodiments, the data storage 140 may take different forms. In one embodiment, the data storage 140 is part of the software builder server 110 and/or the tool provider 130. For example, the data storage 140 is part of the local storage (e.g., hard drive, memory card, data server room) of the software builder server 110 and/or the tool provider 130. In some embodiments, the data storage 140 is a network-based storage server (e.g., a cloud server). The data storage 140 may be a third-party storage system such as AMAZON AWS, DROPBOX, RACKSPACE CLOUD FILES, AZURE BLOB STORAGE, GOOGLE CLOUD STORAGE, etc.

A user device 150 may be a device that is operated by an end user of the dynamic layout software program 120. A user device 150 may include a dynamic user interface 152, which receives input and displays output for the dynamic layout software program 120. The user device 150 can be any personal or mobile computing devices such as smartphones, tablets, notebook computers, laptops, desktop computers, and smartwatches as well as any home entertainment device such as televisions, video game consoles, television boxes, receivers, or any other suitable electronic devices. The software builder server 110 can present information received from executing the dynamic layout software program 120 to an end user, for example in the form of user interfaces (e.g., the dynamic user interface 152). The end user device 150 may communicate with the dynamic layout software program 120 via the network 170.

The dynamic user interface 152 may take different forms. In one embodiment, the dynamic user interface 152 may be an interface displayed within a web browser such as CHROME, FIREFOX, SAFARI, INTERNET EXPLORER, EDGE, etc. and the dynamic layout software program 120 may be a web application that is run by the web browser. In one embodiment, the dynamic user interface 152 is part of the application that is install in the end user device 150. For example, the end user device 150 may be the front-end component of a mobile application or a desktop application. In one embodiment, the dynamic user interface 152 is a graphical user interface (GUI) which includes graphical elements and user-friendly control elements.

The blueprint determination ML model 160 is a machine-learning model that analyzes the semantic representation from the semantic abstraction layer 210 to generate an execution blueprint to be stored at the computational storage 144. A semantic representation that specifies at least a user intent and a set of parameters for fulfilling the user intent. The software builder server 110 may apply the blueprint determination ML model 160 to the semantic representation including the user intent and the set of parameters to generate an execution blueprint. In some embodiments, the execution blueprint may include 1) criteria for matching the execution blueprint to the semantic representation, 2) a set of procedural slots, which specifies at least one function for performing a task, and 3) identifiers of one or more external executable routine tools in the respective procedural slots. While these three components are listed as examples that may be included in an execution blueprint, in various embodiments, an execution blueprint may include fewer, additional, or different components. A function in a procedural slot may take the form of software executable function. However, in some embodiments, those functions may not need to be written in a complete source code format. Instead, the function may include key routine or parameter descriptions and a machine learning model (e.g., an LLM) may be used to generate the executable and debugged function as part of the generation of the ephemeral instructions. In some embodiments, the blueprint determination ML model 160 may also receive an input including various information that is needed to generate an execution blueprint. For example, the blueprint determination ML model 160 may access the tool providers 130 to obtain information of the executable routine tools, input any text for language models, have modalities like images for vision or other models, etc.

The generated execution blueprint connects the functional components (e.g., executable routine tools) to transform the input and output data between the procedural slots and the executable routine tools. The generated execution blueprint may be stored in the computational storage 144 and paired with corresponding semantic representation which is stored at semantic storage 142. The execution blueprint may be identified by an identifier. When receiving a new user input that can be represented by a similar semantic representation stored in the semantic storage 142, the software builder server 110 may skip the blueprint determination ML model 160 and directly identify a matched execution blueprint from the computational storage 144. The software builder server 110 may then cause the dynamic layout software program 120 to retrieve the identified blueprint with an execution blueprint identifier and use the identified execution blueprint to generate a dynamically determined response.

The network 170 provides connections to the components of the system environment 100 through one or more sub-networks, which may include any combination of local area and/or wide area networks, using both wired and/or wireless communication systems. In one embodiment, a network 170 uses standard communications technologies and/or protocols. For example, a network 170 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 170 may be represented using any suitable format, such as hypertext markup language (HTML), extensible markup language (XML), JavaScript object notation (JSON), structured query language (SQL). In some embodiments, some of the communication links of a network 170 may be encrypted using any suitable technique or techniques such as secure sockets layer (SSL), transport layer security (TLS), virtual private networks (VPNs), Internet Protocol security (IPsec), etc. The network 170 also includes links and packet switching networks such as the Internet.

### Dual-Layer Software Program

FIG. 2A is a conceptual diagram illustrating an example dual-layer structure for a layout software program, in accordance with one or more embodiments. The dynamic layout software program 120 may include a semantic abstraction layer 210 and a computational abstraction layer 220.

The semantic abstraction layer 210 analyzes an input from an end user directed the dynamic layout software program 120 and generates a semantic representation of the input. The dynamic layout software program 120 may determine a user intent associated with the input. In some implementations, the semantic abstraction layer 210 may operate in the realm of human thought, design principles, and desired outcomes, and the like. The semantic abstraction layer 210 may use machine learning models (e.g., language models) and/or natural language processing techniques to learn and determine a representation of what users want to achieve. The semantic abstraction layer 210 may also determine a set of parameters specifying how to achieve the users' intent.

FIG. 2B is a block diagram graphically illustrating a process for generating a representation of a user input in the semantic abstraction layer, in accordance with one or more embodiments. The process of generating a representation of a user input may involve the semantic abstraction layer 210 of the dynamic layout software program 120. As shown in FIG. 2B, the software builder server 110 analyzes the user input 222 to identify the user intent 224 associated with the user input 222. In some implementations, the software builder server 110 may apply a machine learning model, such as an LLM, to the user input 222. The user input 222 may include natural languages, and the machine learning model may use natural language processing techniques to parse the user input 222 into tokens by breaking the user input 222 into smaller units, such as words or subwords. In some cases, the LLM may include syntactic analysis for determining the grammatical structure of the user input 222 to determine relationships between words. The software builder server 110 may perform named entity recognition (NER) extract specific information such as names, locations, dates, and product references, and semantic role labeling (SRL) to assign functional roles to different words in a sentence, such as identifying the agent, recipient, and object of an action. In one embodiment, the software builder server 110 may categorize the user input 222 into predefined intent classes. The intent class may have a hierarchical structure, such as a root intent category “Booking a Flight” with a child intent category “locations,” etc. Each intent may be identified with a unique identifier which may be associated with the semantic representation.

In some embodiments, the LLM may use previous historical user interactions, user preferences, domain knowledges, etc. as context for determining the user intent 224. For instance, the LLM may utilize previous interactions, track short-term and/or long-term context, etc., to retain information such as user preferences or previously mentioned entities. The LLM may detect and collect information in the user input 222 that are required for fulfilling the user intent user intent 224. In some embodiments, the software builder server 110 may access knowledge bases, such as the semantic storage 142 in the data storage 140, or an external data source to obtain additional input data to analyze user input 222. The software builder server 110 may determine a domain (i.e., a category or field of intents) associated with the user input 222 and determine the user intent 224 associated with the determined domain. In some cases, the software builder server 110 may access external data sources, e.g., via application programming interfaces (APIs) or other third-party sources to fetch entity values corresponding to a domain.

In some embodiments, the software builder server 110 may input the determined user intent 224 and the context information to a machine learning model to determine a set of parameters for fulfilling the user intent 224. The set of parameters may include various dimensions. For example, the dimensions may include a data dimension 226A, a design dimension 226B, and an experience dimension 226C. The data dimension 226A may refer to the content of the user input 222. In some embodiments, the data dimension 226A may specify the information structure and relationships included in the content of the user input 222. In some cases, the data dimension 226A may include both explicit and implicit data requirements. For example, when a user describes a requirement for building a “team dashboard,” the parameters may include the surface-level data points, the underlying relationships and hierarchies that make the dashboard meaningful, e.g., team structures, reporting relationships, project associations, and other contextual information that gives the data meaning.

The design dimension 226B may refer to the view or visual representation of the dynamic layout software program 120. The design dimension 226B may specify how users envision their interface appearing and functioning. The design dimension 226B may reflect the user's visual preferences and the underlying principles and patterns that will make the interface effective for its intended purpose. The software builder server 110 may determine the design dimension 226B with explicit design instructions (e.g., located at a prominent position in the UI) and implicit preferences derived from examples, references, or user reactions to suggestions. In some implementations, the design dimension 226B may specify the runtime layout elements in the dynamic layout software program 120. The design dimension 226B of the parameters may include layout parameters, such as, text box, display components, interactive user interface element, etc.

The experience dimension 226C reflects how users expect to interact with their interface. In some implementations, the experience dimension 226C may refer to desired UI behaviors, workflows, and interaction patterns of the dynamic layout software program 120. Similarly, the software builder server 110 may determine the experience dimension 226C based on explicit interaction requirements and/or implicit assumptions about user behavior, understanding temporal and spatial relationships between different interface elements. For instance, when capturing requirements for a “multi-step form,” the software builder server 110 may determine the experience dimension 226C with a complete representation of the expected user journey, including navigation patterns, validation requirements, state preservation, and feedback mechanisms.

The software builder server 110 generates a representation 228 using the user intent 224 and the set of parameters to represent the user input 222. The representation 228 may be stored in a structured format, and the structured format may be platform-agnostic. The representation 228 captures what needs to be built without prescribing how it should be implemented. For example, the representation 228 may indicate the functions/tasks to be performed to fulfill the user intent, without dictating the specific executable routine tools to perform such functions/tasks, or the specific layout of the UI of the dynamic layout software program 120. By maintaining these representations independent of any implementation details, the software builder server 110 allows users to focus on expressing their requirements and expectations, without considering technical constraints or limitations.

Referring back to FIG. 2A, the computational abstraction layer 220 transforms semantic understanding (e.g., user intent) obtained from the semantic abstraction layer 210 into tasks/functions that can be performed by the software builder server 110, various platforms, and/or third-party software applications. The computational abstraction layer 220 may handle various programming tasks such as identifying preexisting applicable routines, creating functions, defining variables, or implementing logic. The computational abstraction layer 220 may determine the implementations corresponding to each of the three dimensions (e.g., data dimension 226A, design dimension 226B, and experience dimension 226C) of the representation 228. In some embodiments, the computational abstraction layer 220 may perform the task by accessing an executable routine providing server 130 and deploy existing routine tools hosted by the tool provider 130, such as microservices, pre-written software module, and software applications.

In one example, the computational abstraction layer 220 may have access to a database of execution blueprints, such as either through saving the database in the computational abstraction layer 220 or through an API call to an external database. An execution blueprint may correspond to the data dimension of a semantic representation. The computational abstraction layer 220 may identify an execution blueprint to generate the data dimension of a dynamically determined response to the user input. The execution blueprints may be pre-generated. The execution blueprints may include functional components (e.g., procedural slots) and executable routine tools that may be integrated to create a set of instructions, when executed, generate a dynamically determined response to the user input. The execution blueprint may specify the data to be generated and how the data will be generated. For example, when implementing a recipe display, execution blueprints may include components for structured content display, image galleries, ingredient lists, and step-by-step instructions, along with utilities for handling recipe data.

In some embodiments, the computational abstraction layer 220 may generate the execution blueprints using machine learning models. For example, the computational abstraction layer 220 may employ one or more language models and NLP techniques, such as large language models (LLMs), to integrate procedural slots and executable routine tools into coherent implementations that fulfills the user intent specified by the representation of a user input. For instance, when implementing a recipe card, the computational abstraction layer 220 may integrate an image display, structured text components for ingredients and instructions, and the like. The computational abstraction layer 220 determines an execution blueprint by determining both the individual components as well as their integration to create a cohesive interface that matches the semantic representation.

In some embodiments, the dynamic layout software program 120 may keep an independent feedback loop for each of the semantic abstraction layer 210 and computational abstraction layer 220. In some examples, the semantic abstraction layer 210 and computational abstraction layer 220 may be updated based on its own feedback loop without interfering each other. As shown in FIG. 2A, the semantic abstraction layer 210 evolves whenever users interact with the dynamic layout software program 120. When new users describe their needs or existing users refine their requirements, the semantic abstraction layer 210 compares these interactions with its existing semantic representations. Based on the comparison, the semantic abstraction layer 210 may identify common patterns and variations in how different users conceptualize similar interfaces. While multiple users may request a contact form, each user's specific requirements, from data requirements to interaction expectations, may vary. The semantic abstraction layer 210 uses the feedback loop to build nuanced representations that capture both shared patterns and individual preferences (which may be linked to user information in a user knowledge database in the data storage 140). Over time, the semantic abstraction layer 210 may use the feedback loop to build increasingly personalized interpretations while maintaining a fundamental understanding of common interface patterns.

The computational abstraction layer 220 includes a feedback loop related to technical capabilities. When new building blocks become available, whether new UI components, tools, or platform features, the computational abstraction layer 220 may be updated based on how these additions may better realize existing semantic representations. The update is not limited to direct matches between capabilities and requirements; and the computational abstraction layer 220 also learns to combine building blocks in creative ways to fulfill approximate user intent. For instance, when new interaction components become available, the computational abstraction layer 220 may determine that combining them with existing elements creates implementations that better match users' expected behaviors. In some embodiments, the computational abstraction layer 220 may include a feedback-optimization cycle. For instance, different combinations of existing building blocks may be tested to achieve the same intent in various ways, such as more efficient implementation patterns, fallback options for different technical environments, and deeper understandings of how building blocks may be combined to achieve specific outcomes.

Both feedback loops in the semantic abstraction layer 210 and the computational abstraction layer 220 may involve the use of one or more machine learning models to learn and improve one or more components in the dynamic layout software program 120.

### Example Data Storage

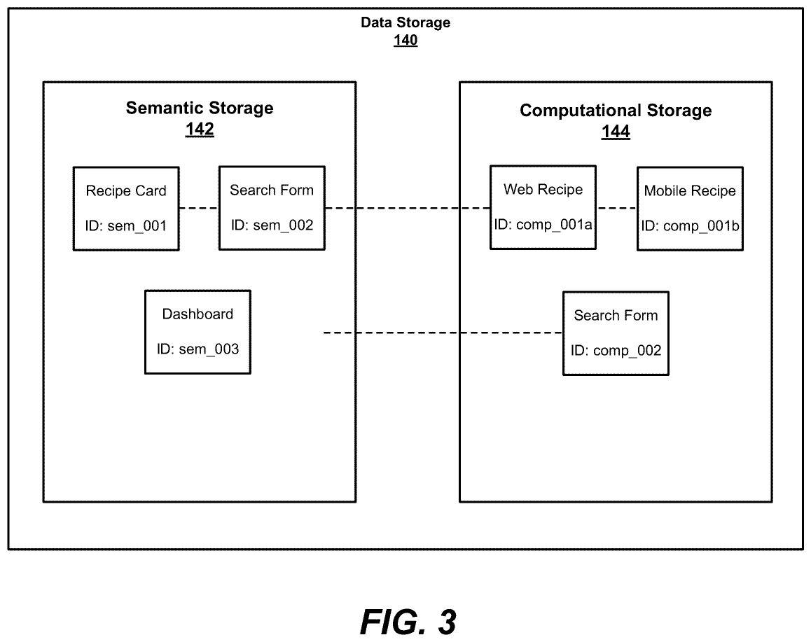

FIG. 3 is a block diagram illustrating an example data storage, in accordance with one or more embodiments. In some embodiments, the data storage 140 may include two separate storage systems, e.g., a semantic storage 142 and a computational storage 144. The two separate storage systems may be configured to preserve the separation between the semantic abstraction layer 210 and computational abstraction layer 220. The semantic storage 142 stores representations of what users want to achieve, while the computational storage 144 maintains the technical implementations that realized these intents. When a UI element is created, both its semantic representation and computational abstraction (e.g., execution blueprints) may be stored as a paired entry in the data storage 140. In some embodiments, the dynamic layout software program 120 may include a set of criteria for matching the respective execution blueprint to a semantic representation. For instance, each semantic representation or an execution blueprint may be identified by a unique identifier. In some implementations, a single semantic representation may be paired with one or more execution blueprints specifying different implementations across platforms or technical environments. Similarly, similar execution blueprints may be paired with different semantic representations, indicating common technical patterns that satisfy different user intents. This independence in storage, combined with the pairing mechanism, enables efficient reuse of both intent patterns and implementation while maintaining the separation principle. When a user describes new requirements, the dynamic layout software program 120 may search through stored semantic representations in the semantic storage 142 to find similar patterns of intent. When matching patterns are found, their paired computational abstractions become candidates for realizing the new requirements, potentially saving significant computational effort in finding implementation approaches that have worked before.

### Generating a Dynamically Determined Response Using Execution Blueprint

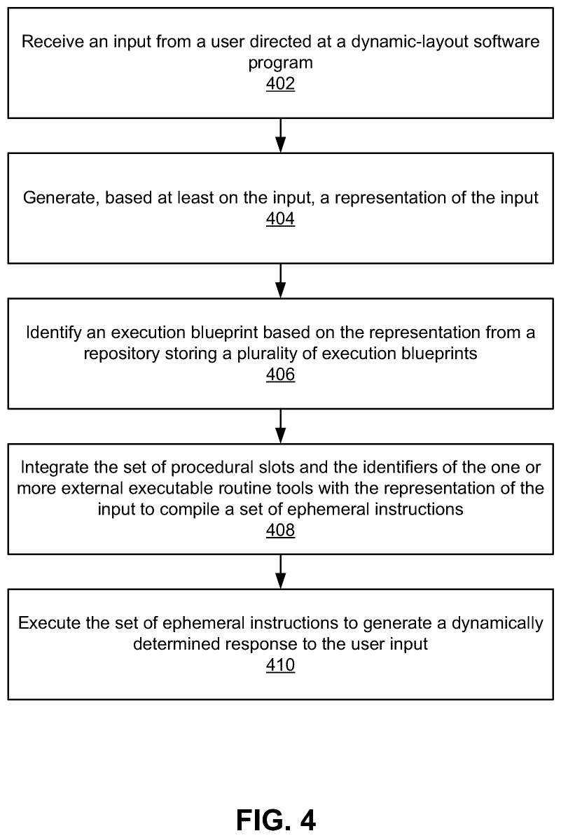

FIG. 4 illustrates an example process 400 for generating a dynamically determined response using an execution blueprint in a dynamic layout software program, in accordance with one or more embodiments. For the particular embodiment discussed in FIG. 4, the software builder server 110 and the tool providers 130 are different servers and operate independently. For example, the software builder server 110 includes one or more computers. A computer associated with the software builder server 110 includes a first processor and first memory. The first memory stores a first set of code instructions that, when executed by the first processor, causes the first processor to perform some of the steps described in the process 400. The tool provider 130 uses different hardware and includes a different computer (or one or more computers) that includes a second processor and second memory. The second memory stores a second set of code instructions that are different from the first set of code instructions. For example, the second set of code instructions may be developed independently using even a different programming language. The second set of code instructions, when executed by the second processor, cause the second processor to perform other steps described in the process 400. While two independent servers are described as an example architecture associated with the process 400, in some embodiments a single server can also perform the entire process 400.

As shown in FIG. 4, the software builder server 110 receives 402 an input from a user directed at the dynamic layout software program 120. The input may include typed text or spoken voice (e.g., a typed or spoken text string). In some embodiments, the input may be in various other forms, such as visual input (e.g., images or videos, etc.), gesture input, etc.

The software builder server 110 generate 404, based at least on the input, a representation of the input. The representation may be a semantic representation representing a user intent associated with the user input and describing information for fulling the user intent. The software builder server 110 may transform the user intent as one or more tasks/functions that can be performed by the dynamic layout software program 120. For example, a user input is “Generate a recipe for chicken pasta,” the software builder server 110 may determine that the corresponding user intent is “recipe generation.” Based on the user input and other context information, the software builder server 110 may also identify a set of parameters for fulfilling the user intent. For example, to fulfill the user intent of “recipe generation,” the software builder server 110 may further determine a set of parameters, such as, ingredients, instructions, images of chicken pasta, teaching video, layout of a UI, interactive UI elements, etc. The software builder server 110 generates a representation that specifies the user intent and the set of parameters for fulfilling the user intent. In some embodiments, the representation may be stored in the data storage 140 and identified by an identifier. In some embodiments, the representation may be associated with the corresponding user input and the association may be stored in the data storage 140.

The software builder server 110 identifies 406 an execution blueprint based on the representation of the user input. The software builder server 110 may identify the execution blueprint from a repository (e.g., the computational storage 144 of the data storage 140) that stores a plurality of execution blueprints. In some embodiments, each execution blueprint may include: 1) criteria for matching the respective execution blueprint to a representation of an input, 2) a set of procedural slots, each slot specifies at least one function for performing a task, and 3) identifiers of one or more external executable routine tools in the respective procedural slots.

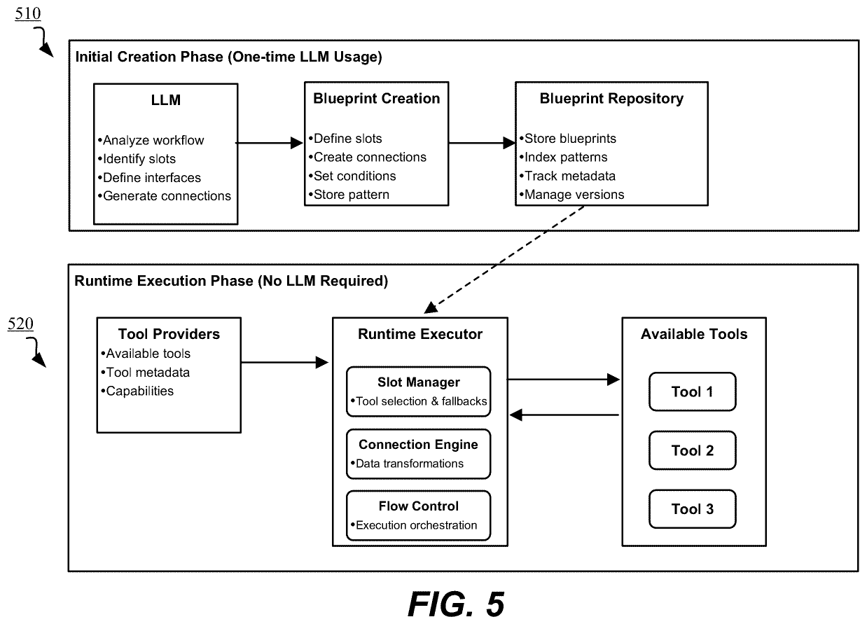

FIG. 5 is a block diagram graphically illustrating a process for using an execution blueprint to generate a dynamically determined response, in accordance with one or more embodiments. As discussed in the previous section, the process of generating or using an execution blueprint involves the computational abstraction layer 220 of the dynamic layout software program 120.

### Execution Blueprint Creation Phase

The software builder server 110 may use one or more blueprint determination ML models 160 to generate an execution blueprint. In some embodiments, the blueprint determination ML model 160 may include an LLM. As shown in an example execution blueprint creation phase 510, the software builder server 110 applies the LLM to the representation of the user input to analyze the workflow to perform a task and create an execution blueprint. In some embodiments, an execution blueprint may include a set of procedural slots, which specifies the tasks/functions and the associated workflow to be performed in the dynamic layout software program 120 to fulfill the user intent. Each procedural slot may correspond to one or more executable routine tools to perform the corresponding function. Instead of directly binding specific executable routine tools to the workflow steps, the procedural slot defines the functionality required at each step. A procedural slot specifies which task/function needs to be accomplished rather than the exact executable routine tools to be used, separating the intent of an operation from its specific implementation. The executable routine tools may be identified by their respective identifiers. In some embodiments, the software builder server 110 may access the tool providers 130 to deploy external executable routine tools; alternatively, the software builder server 110 may provide or support the functions of executable routine tools. The executable routine tools may include pre-built software applications (e.g., a music player, a digital map, a stock trading platform), software modules, machine-learning models (e.g., a large language model (LLM)) and/or microservices (identity service, transaction service, etc.) that are available for the software builder server 110 to use.

In some embodiments, the software builder server 110 may determine a procedural slot by defining slot interfaces in terms of the information needed for the task rather than adhering to any specific tool's interface requirements. For example, in an image generation task, a slot may specify that “style preferences” and “subject description” are required as inputs, and the corresponding output is an “image.” In this way, the procedural slot may correspond to any image generation tool that can provide the required functionality, regardless of their specific input parameter names or structures. In some implementations, a procedural slot may correspond to a set of executable routine tools. For example, the function/task associated with the procedural slot may be performed and/or accomplished by any executable routine tool of the set. In this way, different executable routine tools may be selected for the corresponding procedural slot based on specific requirements or preferences. In one example, for a procedural slot specifying a function of image generation: the same procedural slot may identify one or more executable routine tools to perform the function, e.g., a photorealistic image generator and a cartoon-style generator. The software builder server 110 may dynamically select either of executable routine tools during the execution. The selection may be based on the user's style preferences, content of the user input, etc., without generating separate or different workflows for each style. In some cases, when one of the executable routine tools is not available or fails during execution, the software builder server 110 may automatically select a substitute executable routine tool identified in the same procedural slot to perform the same function/task without disrupting the overall workflow. In this way, a fault tolerance exists within the execution blueprint, requiring no additional error handling logic or LLM intervention during execution. In some embodiments, when new executable routine tools become available to perform a procedural slot's function/task, the software builder server 110 may add the new executable routine tool to a corresponding execution blueprint without modifying the execution blueprint structure.

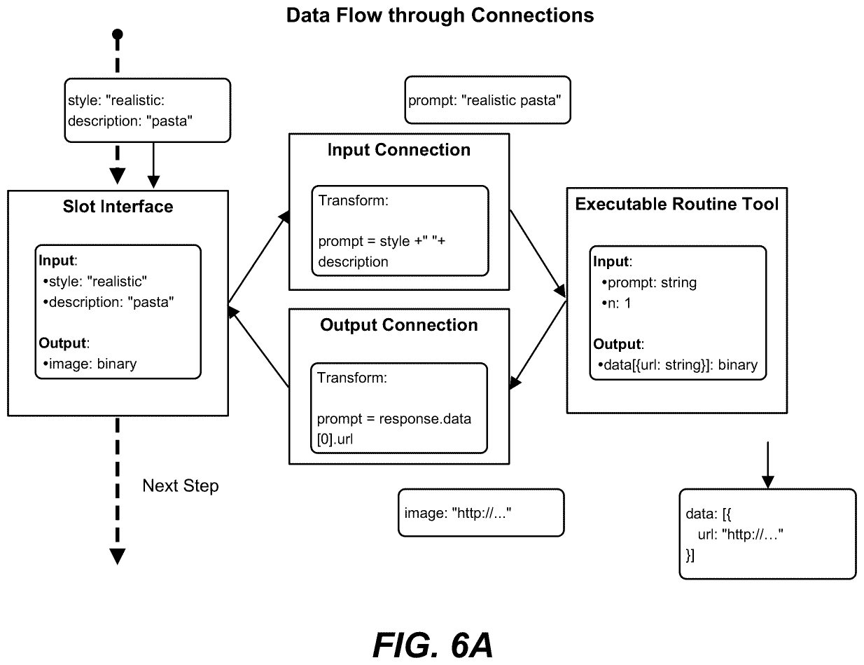

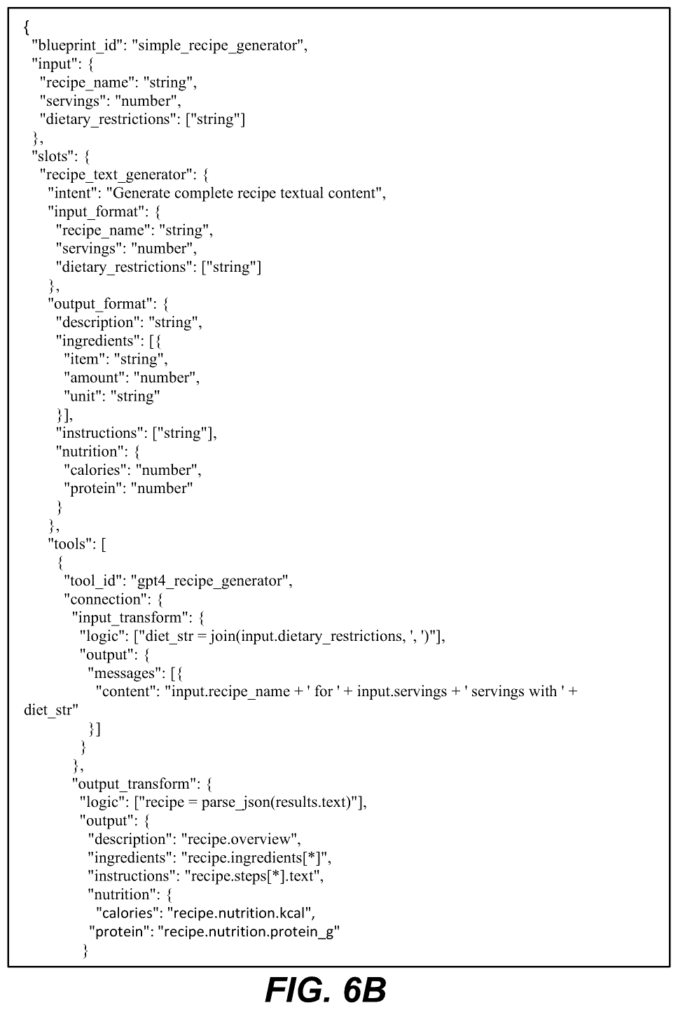

FIG. 6A is a block diagram graphically illustrating a process for data flow through connections in an execution blueprint, in accordance with one or more embodiments. In some embodiments, the software builder server 110 may define connections between procedural slots and the corresponding executable routine tools. A connection may refer to the data transformation between a procedural slots and an executable routine tool. For instance, an executable routine tool may include at least two connections to work with a procedural slot: one that transforms the procedural slot's input format into the executable routine tool's required format, and the other that transforms the executable routine tool's output format to the procedural slot's output format. Similarly, a procedural slot may include connections between a neighboring procedural slot, e.g., a connection that transforms a first procedural slot's output format into a second procedural slot's input format. In some implementations, the software builder server 110 may build the connections using a language model. For example, if an image generation procedural slot requires “style” and “description” as inputs but a specific executable routine tool requires a single “prompt” that combines style and subject information, the software builder server 110 may generate an input connection between the procedural slot and the executable routine tool that merge these parameters compatibly. Similarly, if the executable routine tool returns additional metadata along with the generated image, the software builder server 110 may generate an output connection that extracts just the image data as required by the procedural slot.

In some embodiments, the software builder server 110 may use connections to streamline the process of extending existing execution blueprints with new executable routine tools. When a new executable routine tool becomes available that may potentially fill an existing procedural slot's functionality, the software builder server 110 may only need to generate the pair of input/output connections between that the new executable routine tool and the procedural slot. The executable routine tool then becomes another option for that specific procedural slot in the corresponding execution blueprint, with the connections handling all the complexity of data transformations. In this way, the software builder server 110 may update the execution blueprints over time as new executable routine tools are developed, requiring only the generation of new connections rather than restructuring existing execution blueprints.

The generated execution blueprint may be stored in a blueprint repository, e.g., the computational storage 144 of the data storage 140. The software builder server 110 may determine criteria for matching the respective execution blueprint to a representation of a user input. For example, the criteria may include the corresponding user intent, functions/tasks to be performed, and/or the set of parameters specified by the representation. In some embodiments, the criteria may include workflows and patterns of the functions required to fulfill a user intent. The software builder server 110 may store an association between an execution blueprint and a representation of a user input based on the criteria and/or a level of matching. In some implementations, the semantic storage 142 may cluster the representations based on their similarities, and the computational storage 144 may cluster the execution blueprints based on their similarities. When receiving a new user input, the software builder server 110 may identify and reuse the generated execution blueprint based on the similarities of the representations of the user inputs. In some implementations, the software builder server 110 may generate new execution blueprint by adding new procedural slots, or removing/modifying existing procedural slots in an existing execution blueprint. In some implementations, the software builder server 110 may train the blueprint determination ML model 160 to learn different variations of the execution blueprints that achieve the same end result through different approaches-whether through different numbers of procedural slots or different procedural slot configurations. The diversity of solutions, combined with usage data and performance metrics, allows the blueprint determination ML model 160 to continuously refine the execution blueprint generation and selection. In some embodiments, when determining a new workflow of functions, the software builder server 110 may use the generated execution blueprints as high-level components that encapsulate proven patterns. The software builder server 110 may generate a higher-level execution blueprint that contains one or more lower-level execution blueprints and/or procedural slots. For example, the software builder server 110 may generate an execution blueprint by incorporating existing execution blueprints as components within procedural slots of new execution blueprints. Through this hierarchical composition, the software builder server 110 may build increasingly complex workflows while maximizing the reuse of proven solutions.

### Runtime Execution Phase

Referring back to FIG. 5, as shown in an example runtime execution phase 520, the software builder server 110 identifies an existing execution blueprint from an execution blueprint repository. When a previously generated execution blueprint is selected for execution, the software builder server 110 reduces the LLM involvement, relying instead on the pre-defined procedural slots and connections to manage executable routine tool interactions. In some implementations, the LLM's role may be reduced to the identification of a matched execution blueprint and/or generation of the execution blueprint's input parameters. From there, the software builder server 110 takes over the execution process, performing executable routine tool selection and executing the workflow automatically.

In some implementations, before execution begins, the software builder server 110 performs a dependency analysis of the procedural slots to evaluate runtime performance. By analyzing how data flows between the procedural slots, the software builder server 110 determines which procedural slots may be executed independently. For example, procedural slots with no interdependencies may be executed in parallel, while procedural slots that depend on outputs from other procedural slots are executed sequentially as their dependencies are satisfied. During execution, each procedural slot in the execution blueprint may follow the defined runtime protocol (e.g., the workflow defined by the procedural slots). When execution reaches a procedural slot, the software builder server 110 first determines which of the executable routine tools included in the procedural slot to be used based on the representation of the user input, current conditions of the executable routine tools, and/or any defined selection criteria. For example, in an image generation workflow, the software builder server 110 may determine the user's style preferences or analyze the input description to determine whether to use a photorealistic or artistic generation tool. In some embodiments, the software builder server 110 may perform the conditional checks through pattern matching (such as checking for certain words), conditions may be defined and evaluated through code-based logic. In same example, the software builder server 110 may use a small language model (SLM) or other machine learning (ML) methods (such as similarity scoring) for the conditional checks. Upon execution, if the selected executable routine tool is deemed unavailable or fails by throwing errors, the software builder server 110 automatically selects a substitute executable routine tool in the same procedural slot, if available, without requiring LLM intervention.

Referring back to FIG. 4, the software builder server 110 integrates 408 the set of procedural slots and the identifiers of the one or more external executable routine tools with the representation of the input to compile a set of ephemeral instructions. The set of instructions are ephemeral because the instructions are specific to the particular user input, and dynamically vary as the user input varies. When receiving a new user input, the software builder server 110 may generate a new representation which is used to compile the set of instructions to generate a response to the new user input. The execution blueprint may be re-used but the set of instructions are not.

FIG. 6B is an example section of an execution blueprint, in accordance with one or more embodiments. In some embodiments, the ephemeral instructions may include an identifier that identifies the execution blueprint, the procedural slots included execution blueprint, and the executable routine tools included in each procedural slots. In some implementations, the procedural slots' arrangement in the blueprint may define a sequence of exaction of the procedural slots (e.g., workflow of the corresponding functions). In some implementations, the procedural slots with no interdependencies may be executed in parallel. Each procedural slot may include one or more selected executable routine tools which are identified by their respective tool identifiers. The software builder server 110 may compile the instructions by generating the connections between the procedural slots and the executable routine tools. For instance, the compiled instructions may include input connections that transform the procedural slots' standardized inputs into the specific format required by the corresponding executable routine tools. The complied instruction may include output connections that process the executable routine tool's output back into the procedural slot's standardized output format.

Referring back to FIG. 4, the software builder server 110 executes 410 the set of ephemeral instructions to generate a dynamically determined response to the user input. The response may be displayed by the dynamic layout software program 120 in the dynamic user interface 152. In some embodiments, both the content of the response and the dynamic user interface 152 are dynamically generated as a response to the user input. The dynamically generated response may fulfill the identified user intent in the representation of the user input and defined by the set of parameters specified by the representation. In one example, a user input is “Generate a recipe for chicken pasta.” The dynamically generated response may be presented in a dynamic user interface 152. The dynamic user interface 152 may include a text section including ingredients of the recipe, an image section including a plurality of cruise images that are generated by an image generator, a video section including online video teaching how to cook the chicken pasta, and the like.

### Example Machine-Learning Models

In various embodiments, a wide variety of machine learning techniques may be used. Examples include different forms of reinforcement learning (RL), supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, generating the machine learnable execution blueprints may be performed by applying a RL, and other processes may apply one or more machine learning and deep learning techniques.

In various embodiments, the training techniques for a machine-learning model may be reinforcement learning (RL), supervised, semi-supervised, or unsupervised. Using RL to generate an execution blueprint involves training an agent to identify procedural slots each specifying a function for fulfilling a user intent and a set of executable routine tools in the respective procedural slot. The process starts with defining an environment where the agent interacts by identifying a representation of a user input. The representation specifies at least a user intent to be fulfilled by the program and a set of parameters for fulfilling the user intent. The agent begins by exploring different combinations of syntax and commands, receiving feedback through rewards or penalties based on the functionality and correctness of the generated execution blueprint. For instance, if the goal is to generate an execution blueprint, when executed, can generate a dynamically determined response to the user input, the agent is rewarded when the execution blueprint successfully generates the response and penalized for errors or inefficiencies. In some implementations, the RL may include a Q-learning which is a model-free algorithm that learns the value of action-reward pairs (Q-values) without needing a model of the environment. In some implementations, the RL may include policy gradients which is a method that directly adjusts the policy based on the gradient of expected rewards. Over time, through trial and error, the agent learns to optimize its code generation strategy, producing more effective and accurate execution blueprints. This iterative learning process allows the RL agent to improve continuously, leveraging the reward signals to refine its understanding of the execution blueprint and its application.

By way of example, the training set may include multiple past records (e.g., execution blueprints) with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. For example, in a machine-learning model that is used to generate an execution blueprint that include procedural slots and executable routine tools, the features in a feature vector may include a representation of a user input which may include data, design and experience dimensions. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine-learning model may be associated with an objective function, which generates a metric value that describes the objective goal of the training process. The training process may intend to reduce the error rate of the model in generating predictions. In such a case, the objective function may monitor the error rate of the machine-learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in generating an execution blueprint that include procedural slots and executable routine tools, the objective function may correspond to feedback from a software developer or an end user, and the feedback may indicate a level of satisfaction that the generated execution blueprint, when executed, generates a dynamically determined response to the user input. In various embodiments, the error rate may be measured as cross-entropy loss, L1 loss (e.g., the sum of absolute differences between the predicted values and the actual value), L2 loss (e.g., the sum of squared distances).

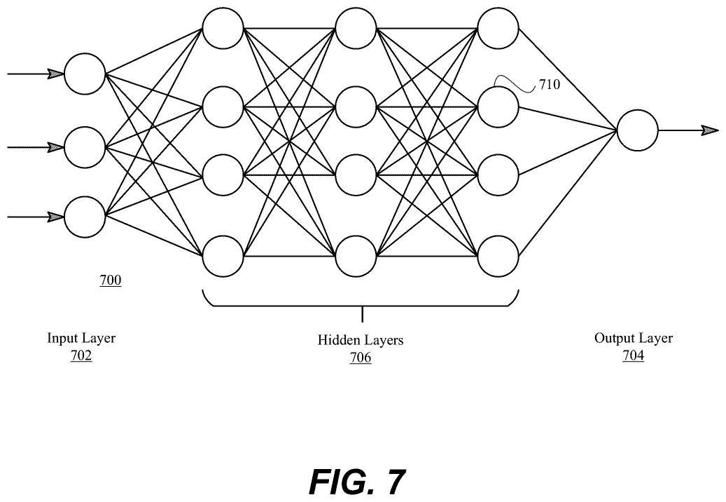

Referring to FIG. 7, a structure of an example neural network is illustrated, in accordance with some embodiments. The neural network 700 may receive an input and generate an output. The input may be the feature vector of a training sample in the training process and the feature vector of an actual case when the neural network is making an inference. The output may be the prediction, classification, or another determination performed by the neural network. The neural network 700 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 700 may vary in different embodiments. In various embodiments, a neural network 700 includes one or more layers 702, 704, and 706, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine-learning model may include certain layers, nodes 710, kernels and/or coefficients. Training of a neural network, such as the NN 700, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine-learning model may include an iterative process that includes iterations of making determinations, monitoring the performance of the machine-learning model using the objective function, and backpropagation to adjust the weights (e.g., weights, kernel values, coefficients) in various nodes 710. For example, a computing device may receive a training set that includes execution blueprints and the associated representations of the user input. Each training sample in the training set may be assigned with labels indicating whether an execution blueprint when executed, can or cannot generate a dynamically determined response to the user input. The computing device, in a forward propagation, may use the machine-learning model to generate predicted execution blueprint. The computing device may compare the predicted execution blueprint with the labels of the training sample. The computing device may adjust, in a backpropagation, the weights of the machine-learning model based on the comparison. The computing device backpropagates one or more error terms obtained from one or more loss functions to update a set of parameters of the machine-learning model. The backpropagating may be performed through the machine-learning model and one or more of the error terms based on a difference between a label in the training sample and the generated predicted value by the machine-learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine-learning model has converged) or after a predetermined number of rounds for a particular set of training samples. The trained machine-learning model can be used for generating execution blueprints or another suitable task for which the model is trained.

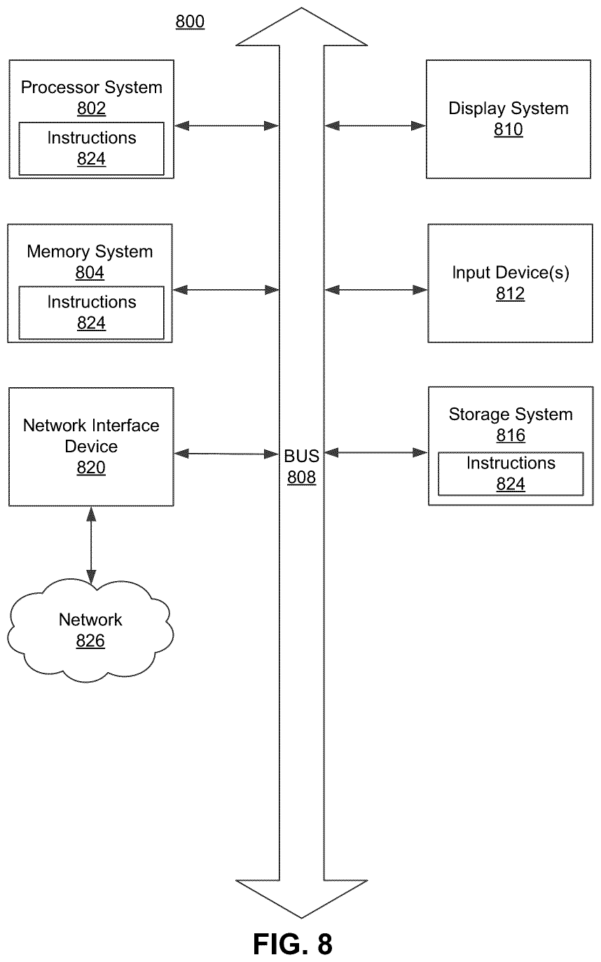

Turning now to FIG. 8, illustrated is an example machine to read and execute computer readable instructions, in accordance with an embodiment. Specifically, FIG. 8 shows a diagrammatic representation of the data processing service 102 (and/or data processing system) in the example form of a computer system 800. The computer system 800 is structured and configured to operate through one or more other systems (or subsystems) as described herein. The computer system 800 can be used to execute instructions 824 (e.g., program code or software) for causing the machine (or some or all of the components thereof) to perform any one or more of the methodologies (or processes) described herein. In executing the instructions, the computer system 800 operates in a specific manner as per the functionality described. The computer system 800 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 800 may be a server computer, a client computer, a personal computer (PC), a tablet PC, a smartphone, an internet of things (IoT) appliance, a network router, switch or bridge, or other machine capable of executing instructions 824 (sequential or otherwise) that enable actions as set forth by the instructions 824. Further, while only a single machine is illustrated, the term “machine” shall also be taken to include any collection of machines that individually or jointly execute instructions 824 to perform any one or more of the methodologies discussed herein.

The example computer system 800 includes a processing system 802. The processor system 802 includes one or more processors. The processor system 802 may include, for example, a central processing unit (CPU), a graphics processing unit (GPU), a neural network processor (NPU), a digital signal processor (DSP), a controller, a state machine, one or more application specific integrated circuits (ASICs), one or more radio-frequency integrated circuits (RFICs), or any combination of these. The processor system 802 executes an operating system for the computing system 800. The computer system 800 also includes a memory system 804. The memory system 804 may include or more memories (e.g., dynamic random access memory (RAM), static RAM, cache memory). The computer system 800 may include a storage system 816 that includes one or more machine readable storage devices (e.g., magnetic disk drive, optical disk drive, solid state memory disk drive).

The storage system 816 stores instructions 824 (e.g., software) embodying any one or more of the methodologies or functions described herein. The instructions 824 may also reside, completely or at least partially, within the memory system 804 or within the processing system 802 (e.g., within a processor cache memory) during execution thereof by the computer system 800, the main memory 804 and the processor system 802 also constituting machine-readable media. The instructions 824 may be transmitted or received over a network 826, such as the network 826, via the network interface system 820.

The storage system 816 should be taken to include a single medium or multiple media (e.g., a centralized or distributed database, or associated caches and servers communicatively coupled through the network interface system 820) able to store the instructions 824. The term “machine-readable medium” shall also be taken to include any medium that is capable of storing instructions 824 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 800 can include a display system 810. The display system 810 may driver firmware (or code) to enable rendering on one or more visual devices, e.g., drive a plasma display panel (PDP), a liquid crystal display (LCD), or a projector. The computer system 800 also may include one or more input/output systems 812. The input/output (IO) systems 812 may include input devices (e.g., a keyboard, mouse (or trackpad), a pen (or stylus), microphone) or output devices (e.g., a speaker). The computer system 800 also may include a network interface system 820. The network interface system 820 may include one or more network devices that are configured to communicate with an external network 826. The external network 826 may be a wired (e.g., ethernet) or wireless (e.g., WiFi, BLUETOOTH, near field communication (NFC).

The processor system 802, the memory system 804, the storage system 816, the display system 810, the IO systems 812, and the network interface system 820 are communicatively coupled via a computing bus 808.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter which can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A system comprising:
one or more computer processors; and
one or more computer-readable mediums comprising stored instructions that, when executed by the one or more computer processors, cause the system to:
receive an input from a user directed at a dynamic layout software program;
generate, based at least on the input, a representation of the input, the representation specifying at least a user intent to be fulfilled by the program and a set of parameters for fulfilling the user intent;
identify, based on the representation, an execution blueprint from a repository storing a plurality of execution blueprints, wherein each of the plurality of execution blueprints comprises: 1) criteria for matching the respective execution blueprint to a representation of an input, 2) a set of procedural slots, each specifying at least one function for fulling a user intent, and 3) identifiers of one or more external executable routine tools in the respective procedural slots;
integrate the set of procedural slots and the identifiers of the one or more external executable routine tools with the representation of the input to compile a set of ephemeral instructions; and
execute the set of ephemeral instructions to generate a dynamically determined response to the user input.

2. The system of claim 1, wherein the instructions to generate one of the plurality of execution blueprints cause the computer processors to:
receive a training representation specifying a training user intent and a set of training parameters associated with the training user intent;
apply a first machine-learning model to the training user intent and the set of training parameters to determine a set of functions for fulfilling the training user intent,
apply a second machine-learning model to the set of functions to generate an execution blueprint comprising a set of procedural slots, each executable unit identifying a list of external executable routine tools; and
store, in the repository, the execution blueprint and an association between the execution blueprint and the training representation.

3. The system of claim 1, wherein the instructions to execute the set of ephemeral instructions cause the computer processors to:
execute the functions specified in the set of procedural slots in the execution blueprint.

4. The system of claim 1, wherein the instructions to generate the set of ephemeral instructions cause the computer processors to:
generate, based on the representation, a first input to a first procedural slot in the identified execution blueprint;
transform the first input to the first procedural slot to an input to at least one external executable routine tool in the first procedural slot;
receive an output from executing the at least one external executable routine tool with the transformed input to the at least one external executable routine tool; and
transform the output from the at least one external executable routine tool as a first output of the first procedural slot.

5. The system of claim 4, wherein the instructions to generate the set of ephemeral instructions cause the computer processors to:
receive the first output from the first procedural slot;
generate a second input to a second procedural slot based at least on the representation and the first output from the first procedural slot; and
transmit the second input to the second procedural slot.

6. The system of claim 1, wherein the instructions to generate a representation of the input cause the computer processors to:
apply a language model to the user input to identify the user intent and the set of parameters.

7. The system of claim 1, wherein the set of parameters comprises a data dimension, a design dimension, and an experience dimension.

8. A non-transitory computer readable storage medium comprising stored program code, the program code comprising instructions, the instructions when executed causes a processor system to:
receive an input from a user directed at a dynamic layout software program;
generate, based at least on the input, a representation of the input, the representation specifying at least a user intent to be fulfilled by the program and a set of parameters for fulfilling the user intent;
identify, based on the representation, an execution blueprint from a repository storing a plurality of execution blueprints, wherein each of the plurality of execution blueprints comprises: 1) criteria for matching the respective execution blueprint to a representation of an input, 2) a set of procedural slots, each specifying at least one function for fulling a user intent, and 3) identifiers of one or more external executable routine tools in the respective procedural slots;
integrate the set of procedural slots and the identifiers of the one or more external executable routine tools with the representation of the input to compile a set of ephemeral instructions; and
execute the set of ephemeral instructions to generate a dynamically determined response to the user input.

9. The non-transitory computer readable storage medium of claim 8, wherein the instructions to generate one of the plurality of execution blueprints cause the processor system to:
receive a training representation specifying a training user intent and a set of training parameters associated with the training user intent;
apply a first machine-learning model to the training user intent and the set of training parameters to determine a set of functions for fulfilling the training user intent,
apply a second machine-learning model to the set of functions to generate an execution blueprint comprising a set of procedural slots, each executable unit identifying a list of external executable routine tools; and
store, in the repository, the execution blueprint and an association between the execution blueprint and the training representation.

10. The non-transitory computer readable storage medium of claim 8, wherein the instructions to execute the set of ephemeral instructions cause the processor system to:
execute the functions specified in the set of procedural slots in the execution blueprint.

11. The non-transitory computer readable storage medium of claim 8, wherein the instructions to generate the set of ephemeral instructions cause the processor system to:
generate, based on the representation, a first input to a first procedural slot in the identified execution blueprint;
transform the first input to the first procedural slot to an input to at least one external executable routine tool in the first procedural slot;
receive an output from executing the at least one external executable routine tool with the transformed input to the at least one external executable routine tool; and
transform the output from the at least one external executable routine tool as a first output of the first procedural slot.

12. The non-transitory computer readable storage medium of claim 11, wherein the instructions to generate the set of ephemeral instructions cause the processor system to:
receive the first output from the first procedural slot;
generate a second input to a second procedural slot based at least on the representation and the first output from the first procedural slot; and
transmit the second input to the second procedural slot.

13. The non-transitory computer readable storage medium of claim 8, wherein the instructions to generate a representation of the input cause the processor system to:
apply a language model to the user input to identify the user intent and the set of parameters.

14. The non-transitory computer readable storage medium of claim 8, wherein the set of parameters comprises a data dimension, a design dimension, and an experience dimension.

15. A computer-implemented method, comprising:
receiving an input from a user directed at a dynamic layout software program;
generating, based at least on the input, a representation of the input, the representation specifying at least a user intent to be fulfilled by the program and a set of parameters for fulfilling the user intent;
identifying, based on the representation, an execution blueprint from a repository storing a plurality of execution blueprints, wherein each of the plurality of execution blueprints comprises: 1) criteria for matching the respective execution blueprint to a representation of an input, 2) a set of procedural slots, each specifying at least one function for fulling a user intent, and 3) identifiers of one or more external executable routine tools in the respective procedural slots;
integrating the set of procedural slots and the identifiers of the one or more external executable routine tools with the representation of the input to compile a set of ephemeral instructions; and
executing the set of ephemeral instructions to generate a dynamically determined response to the user input.

16. The computer-implemented method of claim 15, wherein generating one of the plurality of execution blueprints comprises:
receiving a training representation specifying a training user intent and a set of training parameters associated with the training user intent;
applying a first machine-learning model to the training user intent and the set of training parameters to determine a set of functions for fulfilling the training user intent,
applying a second machine-learning model to the set of functions to generate an execution blueprint comprising a set of procedural slots, each executable unit identifying a list of external executable routine tools; and
storing, in the repository, the execution blueprint and an association between the execution blueprint and the training representation.

17. The computer-implemented method of claim 15, wherein executing the set of ephemeral instructions comprises:
executing the functions specified in the set of procedural slots in the execution blueprint.

18. The computer-implemented method of claim 15, wherein generating the set of ephemeral instructions comprises:
generating, based on the representation, a first input to a first procedural slot in the identified execution blueprint;
transforming the first input to the first procedural slot to an input to at least one external executable routine tool in the first procedural slot;
receiving an output from executing the at least one external executable routine tool with the transformed input to the at least one external executable routine tool; and
transforming the output from the at least one external executable routine tool as a first output of the first procedural slot.

19. The computer-implemented method of claim 18, wherein generating the set of ephemeral instructions comprise:
receiving the first output from the first procedural slot;
generating a second input to a second procedural slot based at least on the representation and the first output from the first procedural slot; and
transmitting the second input to the second procedural slot.

20. The computer-implemented method of claim 15, wherein generating a representation of the input comprises:
applying a language model to the user input to identify the user intent and the set of parameters.
